(19) United States
(12) Patent Application Publication
(10) Pub. No.: US 2025/0374255 A1
(43) Pub. Date: Dec. 4, 2025

(54) RECEIVING APPARATUS FOR AND METHOD OF PERFORMING CHANNEL SMOOTHING RELATED TO WIRELESS RADIO SYSTEM OF OFDM

(71) Applicant: Nordic Semiconductor ASA, Trondheim (NO)

(72) Inventors: George VARGHESE, Hitech City (IN); Karthik Khanna SUBRAMANI, Hitech City (IN)

(21) Appl. No.: 19/219,157

(22) Filed: May 27, 2025

(30) Foreign Application Priority Data
May 28, 2024 (IN) 202411041356
Sep. 6, 2024 (FI) 20246098

(51) Int. Cl. H04W 72/0453; H04W 56/00

(52) U.S. Cl. CPC H04W 72/0453; H04W 56/001

(57) ABSTRACT

A receiver apparatus for performing channel smoothing related to a wireless radio system of an orthogonal frequency division modulation (OFDM) comprises a channel data processing means that determines an estimate of a phase change caused by excess delays of received OFDM symbols based on channel symbol comparisons in frequency domain; compensates the phase change of the channel estimate in the frequency domain based on the estimate of the phase change expressed in the frequency domain; and smoothens the channel estimate by filtering with a selected set of filter coefficients from various sets of filter coefficients, the selected set depending on a guard interval of the training field and/or delay spread that is estimated and/or given. The channel data processing also performs linear interpolation and/or extrapolation on the subcarriers prior to channel smoothing. Channel smoothing may be performed prior to a high efficiency (HE) and/or extremely high throughput (EHT) channel oversampling.

### FIELD

The invention relates to a receiving apparatus for and a method of performing channel smoothing related to a wireless radio system of an orthogonal frequency division modulation (OFDM).

### BACKGROUND

Wireless local area network (WLAN) devices are used in a variety of environments. The WLAN may utilize orthogonal frequency-division multiple access (OFDMA). A transmitter of the OFDM system arranges known symbols that may be called pilots or training fields in a determined manner to the transmission. In more details that can be accomplished by a Long Training Field (LTF) sequence for a preamble of a High Efficiency (HE)-based and Extremely High Throughput (EHT)-based transmission for estimation of a channel. The receiver then estimates the channel using the known information of the received long training fields.

A way to improve the channel estimate of the OFDM systems is channel smoothing that is based on the correlation of the frequency-domain channel responses. However, the channel smoothing may fail to work when the reception is not properly temporally synchronized with the packet, for example. As a result, improvement of the channel smoothing would be welcome.

### BRIEF DESCRIPTION

The present invention seeks to provide an improvement for the channel smoothing.

According to an aspect, there is provided a receiving apparatus for performing channel smoothing related to a wireless radio system of an orthogonal frequency division modulation (OFDM) of claim 1, the receiver apparatus means comprises a channel data processing means that is configured to
determine an estimate of a phase change caused by excess delays of received OFDM symbols based on channel symbol comparisons in frequency domain;
compensate the phase change of the channel estimate in the frequency domain based on the estimate of the phase change expressed in the frequency domain; and
smooth each of the channel estimate by filtering with a selected set of filter coefficients from various sets of filter coefficients, the selected set depending on a guard interval of the training field and/or estimated/given delay spread. The channel estimation is performed in the frequency domain and performing channel smoothing also in the frequency domain is technically advantageous for the postprocessing computation. This improves the channel estimate.

In an embodiment, the channel data processing means is configured to perform the following prior to the estimation of the phase change; receive a frequency domain channel estimate of all subcarriers as a vector; center the vector of coefficients of the channel estimate by setting a DC sub-carrier at the center between the edges of the vector of the coefficients of the channel estimate. This may ensure continuity and correlation between subcarriers which is enhanced in smoothing operation.

In an embodiment, the compensation of the phase change by the channel data processing means is configured to compensate cyclic delay diversity (CDD) in conjunction with the compensation of the phase change related to the excess delay. In this manner, the excess delay caused by various reasons will be taken into account for each transmitter/receiver antenna pair channel estimate.

In an embodiment, the channel data processing means is configured to interpolate and/or extrapolate null and/or pilot sub-carriers, where the channel estimate is discontinuous, based on one or more neighboring sub-carriers in the frequency domain prior to the channel smoothing.

In an embodiment, the channel data processing means is configured to perform a linear interpolation and/or extrapolation on the subcarriers prior to channel smoothing. Interpolation and/or extrapolation prevents a possibility of a large variation in pilot signals and/or null subcarriers.

In an embodiment, the channel data processing means is configured to save channel coefficients of pilot sub-carriers prior to the interpolation for processing posterior to channel smoothing.

In an embodiment, the channel data processing means is configured to form the phase change relating to the time shift of synchronization between reception and symbol boundaries of the channel symbols for the compensation of the phase change.

In an embodiment, the channel data processing means is configured to multiply the channel estimate expressed in the frequency domain by a counter-phase-shift expressed in the frequency domain, the counter-phase-shift being defined by the angle relating to the time shift.

In an embodiment, the channel data processing means is configured to perform the channel smoothing without ramp up and ramp down subcarrier symbols.

In an embodiment, the channel data processing means is configured to remove gamma rotations prior to the phase change estimation.

In an embodiment, the channel data processing means is configured to oversample 1x and/or 2x high-efficiency and/or extremely-high-throughput long training field type.

In an embodiment, the channel data processing means is configured to form an average excess delay of the delay spread as a center of gravity of the channel impulse response power for maximizing correlation across the sub-carriers prior to the channel smoothing.

In an embodiment, the channel data processing means is configured to reduce an average delay of the excess delay for maximizing correlation across the sub-carriers prior to the channel smoothing.

In an embodiment, the channel data processing means is configured to estimate an average excess delay of the received OFDM signal from the frequency domain channel estimates, and correct the average excess delay in the frequency domain.

According to an aspect, there is provided a method for performing channel smoothing by a receiver of a wireless radio system of an orthogonal frequency division modulation (OFDM), the method comprising
determining an estimate of a phase change caused by excess delays of received OFDM symbols based on channel symbol comparisons in frequency domain;
compensating the phase change of each channel estimate in the frequency domain based on the estimate of the phase change expressed in the frequency domain; and
smoothing each channel estimate by filtering with a selected set of filter coefficients from various sets of filter coefficients, the selected set depending on a guard interval of the training field and/or delay spread that is estimated and/or given. The channel estimation is performed in the frequency domain and performing channel smoothing also in the frequency domain is technically advantageous for the postprocessing computation. This improves the channel estimate.

If one or more of the embodiments is considered not to fall under the scope of the independent claims, such an embodiment is or such embodiments are still useful for understanding features of the invention.

### LIST OF DRAWINGS

Example embodiments of the present invention are described below, by way of example only, with reference to the accompanying drawings, in which

FIG. 1 illustrates an example OFDM symbols sequences and guard intervals;

FIG. 2A illustrates an example of a time domain channel and a corresponding frequency domain channel with an observation window in one position;

FIG. 2B illustrates an example of a time domain channel and a corresponding frequency domain channel with an observation window in another position;

FIG. 2C illustrates an example of a time domain channel and a corresponding frequency domain channel with an observation window in still another position;

FIG. 3 illustrates an example of frequency bands for filtering;

FIG. 4 illustrates a general example of an OFDM system where a transmitter transmits a signal over a Rayleigh+AWGN channel to a receiver;

FIG. 5 illustrates an example of an apparatus for performing channel smoothing;

FIG. 6A illustrates an example of estimating a phase change as an angle;

FIG. 6B illustrates an example of forming an adjusted channel estimate based on the phase change;

FIG. 7A illustrates an example of an algorithm for RTL implementation for 2x to 4x channel oversampling;

FIG. 7B illustrates another example of an algorithm for the RTL implementation for 1x to 4x channel oversampling; and

FIG. 8 illustrates of an example of a flow chart of a method for performing channel smoothening.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment.

The articles “a” and “an” give a general sense of entities, structures, components, compositions, operations, functions, connections or the like in this document. Note also that singular terms may include pluralities.

Single features of different embodiments may also be combined to provide other embodiments. Furthermore, words “comprising” and “including” should be understood as not limiting the described embodiments to consist of only those features that have been mentioned and such embodiments may also contain features/structures that have not been specifically mentioned. All combinations of the embodiments are considered possible if their combination does not lead to structural or logical contradiction.

Channel smoothing may be performed by an apparatus of a receiver apparatus which includes the high efficiency (HE) (1xHELTF, 2×HELTF and 4xHELTF) and/or extremely high throughput (EHT) (1xEHTLTF, 2xEHTLTF and 4xEHTLTF) channel oversampling used in RX OFDM path, RX OFDM standing for receiver orthogonal frequency division modulation. Performance may be improved and channel smoothing also relates to the candidate for register transfer level (RTL) implementation.

For an HE physical layer protocol data unit (PPDU), channel estimation can be done on 1x/2x/4x high efficiency long training field (HELTF) preamble field. For an EHT physical layer protocol data unit (PPDU), channel estimation can be done on 1x/2x/4x extremely high throughput long training field (EHTLTF) preamble field. The estimated channel can then be post-processed with channel smoothing and channel interpolation (oversampling).

Channel smoothing is a scheme to improve the channel estimate by making use of channel correlations in frequency domain. It can be assumed that the power in the time domain channel taps is mainly concentrated in a small window (root mean square delay spread can be used as a measure) around the centre of energy (Excess Delay). Simple OFDM systems work on the assumption that maximum delay spread does not exceed Guard Interval (GI) which is a quarter or less of the normal OFDM symbol. Since time domain channel is short, the frequency domain equivalent channel coefficients thus appear correlated. This correlation can be made use of in improving channel estimates, especially at higher noise levels. It is possible to null out time domain channel estimates outside the GI window, and assume they are due to noise. The equivalent operation in frequency domain is a convolution operation. The channel estimation itself is performed in frequency domain, so performing smoothing operation in frequency domain as a postprocessing step is advantageous computationally.

In the wireless local area network (WLAN) HE or EHT standard, on HE-LTF or EHT-LTF there is an option to load every fourth (1xHE-LTF, 1xEHT-LTF), second (2x-HE-LTF, 2x-EHT-LTF) or all (4x-HE-LTF, 4x-EHT-LTF) subcarrier with training field which assists in data aided channel estimation on those subcarriers. The channel estimates on the missing subcarriers can be created by interpolation using adjacent available channel estimates. Interpolation is required in case of 1x-HE-LTF,2x-HE-LTF, 1x-EHT-LTF and 2x-EHT-LTF as shown in table below.

| | | | Available | | Required | | |
|---|---|---|---|---|---|---|---|
| | Symbol Period | | Channel Est | | Channel Est | | |
| | without cyclic | | Frequency | | Frequency | | Over sampling |
| LTF Type | prefix or GI | | Resolution | | Resolution | | factor |
| L/HT/VHT LTF | 3.2 | μs | 312.5 | kHz | 312.5 | kHz | 1 |
| 4x-HE-LTF, | 12.8 | μs | 78.125 | kHz | 78.125 | kHz | 1 |
| 4x-EHT-LTF | | | | | | | |
| 2x-HE-LTF, | 6.4 | μs | 156.25 | kHz | 78.125 | kHz | 2 |
| 2x-EHT-LTF | | | | | | | |
| 1x-HE-LTF, | 3.2 | μs | 312.5 | kHz | 78.125 | kHz | 4 |

1x-EHT-LTF

The radio channel can be modelled as a Rayleigh channel with exponential power delay profile. The channel impulse response can be characterised by two parameters, namely Average Channel Excess Delay (τ_{avg}) and RMS Delay Spread (τᵣₘₛ). One or both may be utilized in a channel smoothing filter.

A delay from the instant an observer starts observing the channel, until the first ray of the impulse (or reflection) reaches the observer can be defined the minimum excess delay. This may come from a line-of-sight path. The last ray of the impulse or reflection arrives correspondingly at maximum excess delay. In a noisy environment it is difficult to determine the first and last arriving ray out of noise, particularly the last one, because the power might have died down significantly by then due to multiple reflections. Both the minimum and maximum excess delays are not relevant and not necessarily measurable, but they are helpful for understanding. Information that is useful relates to location at which most of the energy from the impulse is concentrated and how wide the energy distribution over time is. The first one is described by an average excess delay (τ_{avg}) and the latter is an RMS delay spread (τᵣₘₛ). The excess delay spread may cause a number of undesired effects, which may include but not limited to ISI and deteriorated channel estimation.

Average excess delay can be described as the centre of gravity of the channel impulse response power. The weighted average of delay τ can be defined as a ratio between an integrated a channel impulse response (CIR) power P(τ) multiplied by delay τ integrated over delays divided by CIR power P(τ) integrated over delays:

$${τ}_{a v g} = \frac{{\int }_{0}^{∞} τ P ( τ ) d τ}{{\int }_{0}^{∞} P ( τ ) d τ}$$

It is to be noted that the τ_{avg} also depends on at what point the observer starts observing the channel. If the channel observation is started before the first ray arrives there will be a large average excess delay which affects channel smoother and that is a technical problem.

The RMS delay spread is a measure of the spread of the CIR power in time. It is the channel tap power weighted delay difference from the average excess delay (τ_{avg}) defined as:

$${τ}_{r m s} = \sqrt{\frac{{\int }_{0}^{∞} {( τ - {τ}_{a v g} )}^{2} P ( τ ) d τ}{{\int }_{0}^{∞} P ( τ ) d τ}}$$

The distance between the transmitter and the receiver is not relevant to the delay spread. In free space, without scattering or multipaths, whole energy from the impulse can concentrate within a narrow time window (Digital Video Broadcasting—Satellite transmissions, for example). On the other hand, in a multipath scenario, the rays reflected off from scatterers or diffracted arrive at different times and delay spread is more (Digital Video Broadcasting—Terrestrial, Cellular, WLAN, Terrestrial Trunked Radio, for example).

It is assumed that the channel delay spread, τᵣₘₛ, or most of the channel power is within the guard interval (GI), a requirement for inter symbol interference (ISI) free reception.

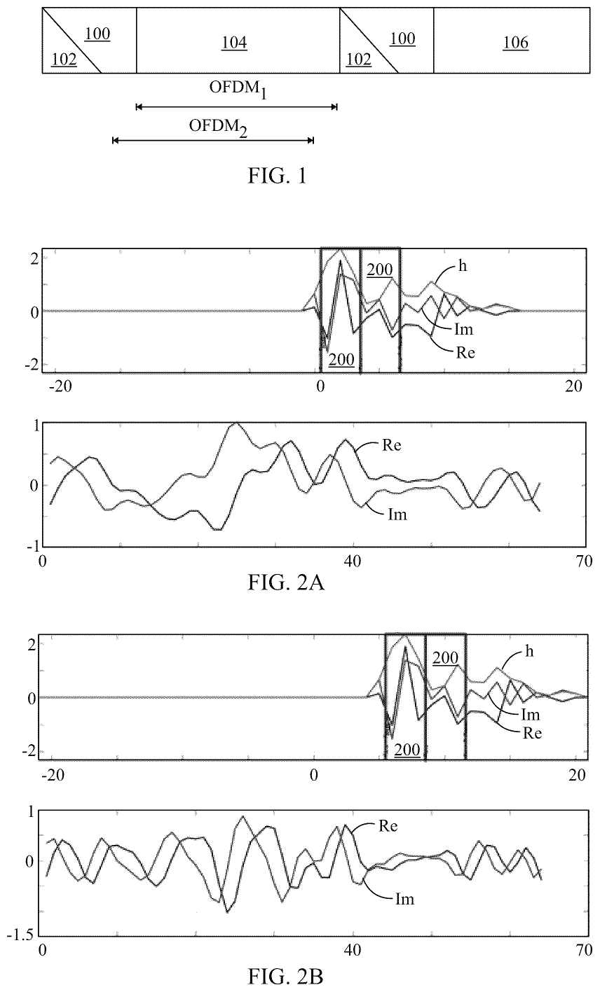

FIG. 1 illustrates an example of guard interval (GI) with cyclic prefix (CP) 100, ISI 102 within GI with reference to an OFDM Symbol 104. GI with CP 100 and ISI 102 precedes also the next symbol 106. Data aided channel estimation is done on LTF/HT-LTF/VHT-LTF/HE-LTF/EHT-LTF OFDM symbols where the transmitted data is known to the receiver.

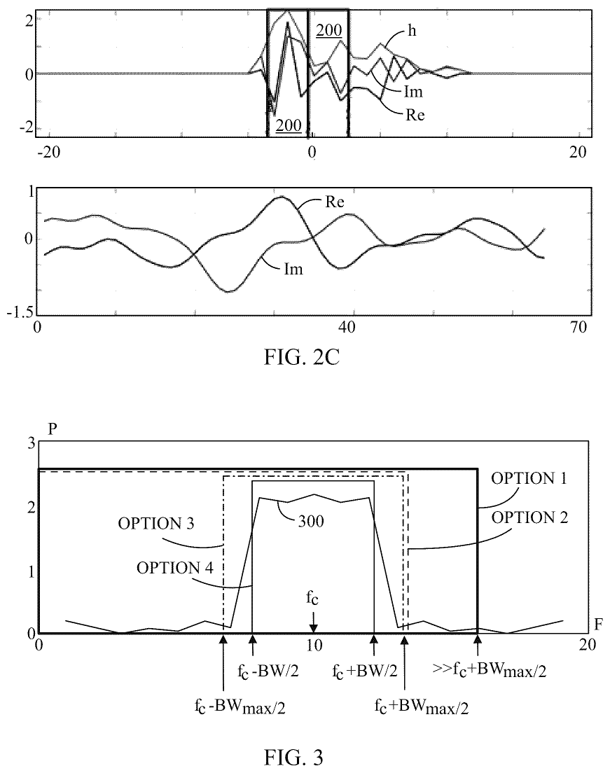

An OFDM window can be positioned anywhere in the ISI free region, of which two cases are illustrated in FIGS. 2A and 2B. Both should give identical performance as they are ISI free. They differ in subcarrier correlation that is also called smoothness.

Received discrete ISI free symbol of length nFft can be converted to frequency domain using discrete Fourier transform (DFFT), optimally implemented by Fast Fourier Transform (FFT), where nFft refers to number of fast Fourier transform points. This is compared (divided) against the actual transmitted data to get the frequency domain channel impulse response. Further payload carrying symbols are equalised using this frequency domain channel estimate. There is no incentive in converting the CIR to time domain, and avoidance of the conversion leads to a technical advantage.

The upper drawing of FIG. 2A presents the time domain channel estimated from OFDM₁. The y-axis (vertical axis) is in an arbitrary scale and time in samples, where a sample period is 50 ns, is on the x-axis (horizontal axis). The lower drawing of FIG. 2A presents a frequency domain channel estimated from OFDM₁. The y-axis (vertical axis) is in an arbitrary scale and frequency in units of subcarrier spacing (312.5 kHz) is in the x-axis (horizontal axis).

If the OFDM window is positioned as in FIG. 2A at the receiver (see OFDM₁), the first sample observed is corresponding to the first ray. In this case, the minimum excess delay is zero. The time and frequency domain impulse responses are shown in FIG. 2A. The channel estimates h correlate well in FIG. 2A resulting in smooth behaviour in the frequency domain. Terms Im and Re refer to imaginary and real parts of the channel estimate, respectively.

The upper drawing of FIG. 2B presents the time domain channel estimated from OFDM₂. The y-axis (vertical axis) is in an arbitrary scale and time in samples, where a sample period is 50 ns, is on the x-axis (horizontal axis). The lower drawing of FIG. 2B presents a frequency domain channel estimated from OFDM₂. The y-axis (vertical axis) is in an arbitrary scale and frequency in units of subcarrier spacing (312.5 kHz) is in the x-axis (horizontal axis).

If the observation window is shifted as in FIG. 2B (see OFDM₂), as the receiver is not perfectly synchronised to the symbol boundaries, the first ray of the CIR can arrive later or earlier. In the case of later arrival, the impulse response will be as in FIG. 2B. Note that τ_{avg} is increased here as the observation started earlier by a few samples. The delay spread remain the same in FIGS. 2A and 2B, see time window 200. Although both channels above are identical, due to the time shift, resulting from positioning of the observation window, the frequency domain correlations (smoothness) of the channel estimates h are lost in case of FIG. 2B, see rapid fluctuations in lower section of FIG. 2B illustrating frequency domain channel. Terms Im and Re refer to imaginary and real parts of the channel estimate, respectively. Channel smoothing works efficiently when the subcarriers are maximally correlated. This can be achieved by both reducing τ_{avg} and/or τᵣₘₛ of which reducing τ_{avg} is practical and technically easier.

FIG. 2C illustrates an example how operations prior to channel smoothing affects a channel estimate. The upper drawing of FIG. 2C presents the time domain channel estimated from a perfectly placed OFDM window. The y-axis (vertical axis) is in an arbitrary scale and time in samples, where a sample period is 50 ns, is on the x-axis (horizontal axis). The lower drawing of FIG. 2C presents a frequency domain channel estimated from said OFDM window. The y-axis (vertical axis) is in an arbitrary scale and frequency in units of subcarrier spacing (312.5 kHz) is on the x-axis (horizontal axis). Note that the centre of gravity of the channel is almost at zero but not necessarily exactly at zero in FIG. 2C. This is because the delay is estimated and corrected. In FIGS. 2A and 2B the delays are not corrected and hence the zero is away from the centre of gravity.

It is advantageous to position the OFDM time window 200 somewhere safe in the middle of ISI free region and then compensate for the delay (centering the CIR). This is performed prior to channel smoothing by a filter. This results in maximum correlation across subcarriers prior to smoothing. The novel algorithm relies on estimating the τ_{avg} from the frequency domain channel estimates directly and correcting it in the frequency domain. In this manner, back and forth conversion of CIR to time domain by inverse digital Fourier transform, (IDFT) estimation of τ_{avg}, centering CIR in time domain and its conversion back to frequency domain by digital Fourier transform for equalisation are avoided.

Cyclic Delay Diversity (CDD) is usually applied in the case of MIMO or MU-MIMO transmission, where multiple Tx antennas or Tx users transmit at the same time and frequency to multiple Rx antennas or Rx users. In this case, transmitted symbol is cyclically shifted in time by a predetermined number of samples. Here the component signals from different Tx antennas or Tx users arriving at a receiver antenna may have gone through different excess delays, delay spreads and CDDs. It is not possible to find one delay estimate for this composite Rx signal or correct it before smoothing. Without centering the CIR in time domain (or equivalent processing in frequency domain) smoothing is not as effective since the subcarriers are not correlated i.e. not smooth. Basically, the frequency domain filter will need higher bandwidth (longer time window) to admit the genuine fast variations accurately. This will also admit more noise unnecessarily which is contrary to the purpose of channel smoother.

FIG. 3 illustrates a useful analogous example from time domain. The y-axis represents power P and the x-axis represents frequency F. Assume filtering out a signal 300 of bandwidth (BW) and removing noise outside that band. Assume additionally that the actual bandwidth and the centre frequency f_{c} are not known although the bandwidth is constrained to maximum value BWₘₐₓ by design. The features below are illustrated in FIG. 3.
Option-1 is a low pass filter (LPF) of arbitrarily high bandwidth (>>BWₘₐₓ) and live with the additional noise admitted outside the signal band. In FIG. 3 it is 0 to 16 MHz.
Option-2 is a LPF with an adaptive bandwidth which estimates f_{c}+BWₘₐₓ/2. In FIG. 3 it is from 0 to 13. Note that only the upper edge is adapted here.
Option-3 is to a band pass filter (BPF) of bandwidth BWₘₐₓ after estimating the signal centre frequency f_{c}. This is more effective than the first two since the noise admitted is only in the BWₘₐₓ. The filter coefficients are programmable so that we could use BW<BWₘₐₓ, too. In FIG. 3 it is from 7 to 13. Edges are not adapted, only the centre frequency is adapted.
Option-4 is to estimate both f_{c} and BW, and this option can perform the optimum BPF of estimated BW centred at estimated f_{c}. In FIG. 3 it is from 8 to 12. Both upper and lower edges are adapted.

The architecture scheme of the channel post-processing should pay attention to the following: different valid combinations of operating bandwidth, (Gamma rotations), signal bandwidth and number of antennas, all possible CDDs, all allowed channel delay spread, and all possible resource unit (RU) allocations in a high efficiency multiuser (HEMU) frame. The schemes should take care of the discontinuities in the channel estimate in frequency domain due to guard carriers on the band edges, null carriers at DC or in between RUs and pilots. Pilot position is fixed. Pilots can introduce discontinuity in channel estimates in some case. Spurious signals and notch filters can also introduce discontinuities in channel estimates, whose position may change dynamically from packet to packet due to CFO (Carrier Frequency Offset). The subcarrier, the frequency of which is equal to the RF center frequency of the transmission, is the DC subcarrier. The DC is a subcarrier that carries no information.

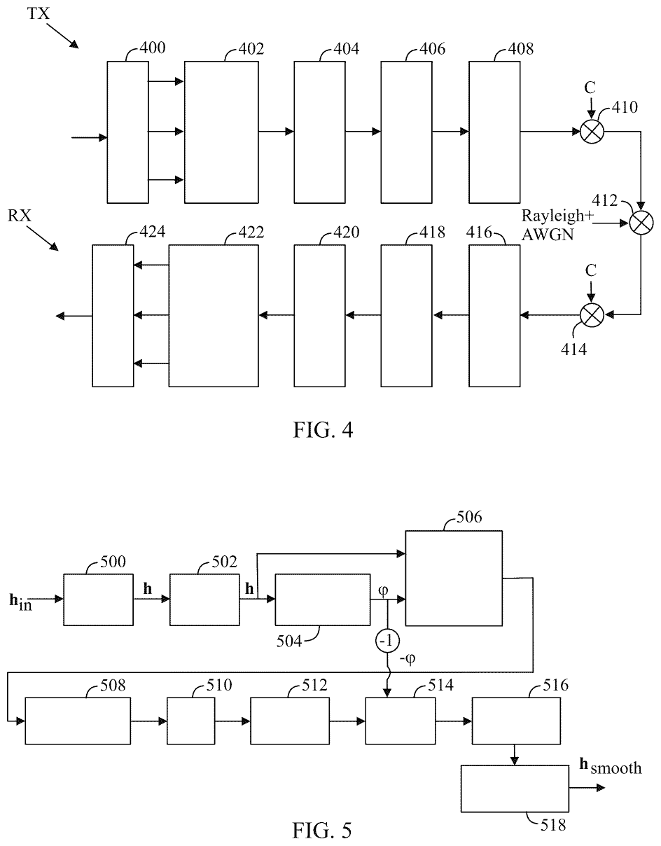

FIG. 4 illustrates a general example of the OFDM-system. Data in serial form is input to a serial/parallel converter 400. The parallel form of data is then modulated using any known and/or suitable modulation method in a modulator 402. The data is thus mapped using digital modulation schemes like binary phase shift keying (BPSK), quadrature phase shift keying (QPSK) or quadrature amplitude modulation (QAM). The number of subcarriers is predefined for the data symbols in one OFDM symbol. The pilots are also inserted to the signal to be transmitted (pilot insertion is shown in FIG. 5). Pilots are predetermined subcarrier symbols that the receiver may use for the channel estimation.

Pilots are not necessarily for channel estimation although it can be used. They are used for estimating and correcting common phase error, carrier frequency offset (CFO) or sampling frequency offset (SFO), some of which could vary from one OFDM symbol to the next.

The modulated data is next transformed into orthogonal frequencies by a block 404 of an IFFT-transform, which may be an inverse discrete Fourier transform (IDFT). CDD is applied and cyclic prefix (CP) is added to the OFDM symbol during GI period as shown in block 406. The cyclic prefix can be attached at the beginning of each time domain OFDM symbol to counteract the distortion caused by ISI in the channel.

CDD—Cyclic Delay Diversity—is used when the same transmit signal is transmitted over multiple antennas. That may allow to avoid unintended beamforming. That may also be useful in separating out channels corresponding to each pair of transmit-receive antennas.

Next, the OFDM symbols are converted to serial form. The signal is converted into an analog form in digital-to-analog converter 408. The analog signal multiplied by a radio frequency carrier C by the transmitter mixer 410. The radio frequency signal then travels through an air-interface or a wired channel 412 to a receiver where the received signal is mixed down by a receiver mixer 414. The air-interface or even a wired-interface can be considered a Rayleigh fading multipath channel with additive white Gaussian noise (AWGN). The channel can be considered to have multiple paths from each transmitting antenna to each receiving antenna. In fact, multiple paths arriving at different times at different power levels results indeed in a delay spread.

The receiver additionally performs for example the following. The signal is converted into digital form by an analog-to-digital converter 416. The nFft samples from each OFDM symbol are extracted in block 418, starting from somewhere in the remaining ISI free region inside Guard Interval (GI) where Cyclic Prefix is sent and the nFft samples are transformed back to modulated data by a block 420 of an FFT-transform. The modulated signal is demodulated by a demodulator 422, and the demodulated signal is converted into serial form in parallel/serial converter 424.

FIG. 5 illustrates an example of an apparatus for performing channel smoothing related to a wireless radio system of an orthogonal frequency division modulation (OFDM). The apparatus is included in the receiver. A frequency domain channel estimate hᵢₙ of all sub-carriers, per se, is formed in a manner known to a person skilled in the art. The channel estimate hᵢₙ is input to the process and gamma rotations that may also be called complex rotations are removed in block 500. Data subcarriers in each 20 MHz in a 40 MHz, 80 MHz or 160 MHz channel is multiplied by a constant gamma factor. This is absorbed in the channel estimates to minimize computations in de-mapping and afterwards. But absorbing it in channel estimates also destroys the correlations in frequency domain and it deteriorates channel smoothing operation which relies on frequency domain correlation. Gamma rotation is removed first by multiplying with the complex conjugate of gamma factors used in the transmitter. As the gamma factor is constant across each 20 MHz it will not have any effect in 20 MHz operation and thus it may be ignored in 20 MHz operation.

The gamma rotations may be reinserted by multiplying with the gamma factors.

In an embodiment, the channel data processing arrangement may save the channel coefficients of pilot sub-carriers in block 502 prior to the interpolation for processing posterior to channel smoothing. The channel coefficients of pilots, which are used as reference signals may be restored in some cases later, are saved in block 502.

The modulation schemes of pilots in various WLAN frame formats differ. Hence, the channel estimates on these locations may have discontinuities although the underlying channel is correlated. This is especially true with multi antenna transmissions. Using them in a channel smoother will corrupt the adjacent subcarriers. The original pilot channel estimates are still needed for common phase error estimation (CPE) at a later stage. Before applying smoothing, channel estimates from these subcarrier locations are saved and zeros are inserted instead. In this manner, they do not influence the excess delay estimation and smoothing.

A channel data processing arrangement determines an estimate of a phase change caused by excess delays of received OFDM symbols based on channel subcarrier symbol comparisons in the frequency domain. It may also be considered that a channel data processing arrangement determines an estimate of a phase change caused by excess delays of each estimated channel frequency response based on channel symbol comparisons in the frequency domain. The channel data processing arrangement thus determines an estimate of a phase change caused by excess delays and CDD (Cyclic Delay Diversity) of the channel estimate between, possibly, each of the transmit antenna and receive antenna pair based on comparison of subcarrier channel estimates in frequency domain. This tries to say that it is not one single channel but a composite channel which needs to be decoupled for enabling the estimation and the compensation. This part of data processing is illustrated in FIG. 5 by block 504.

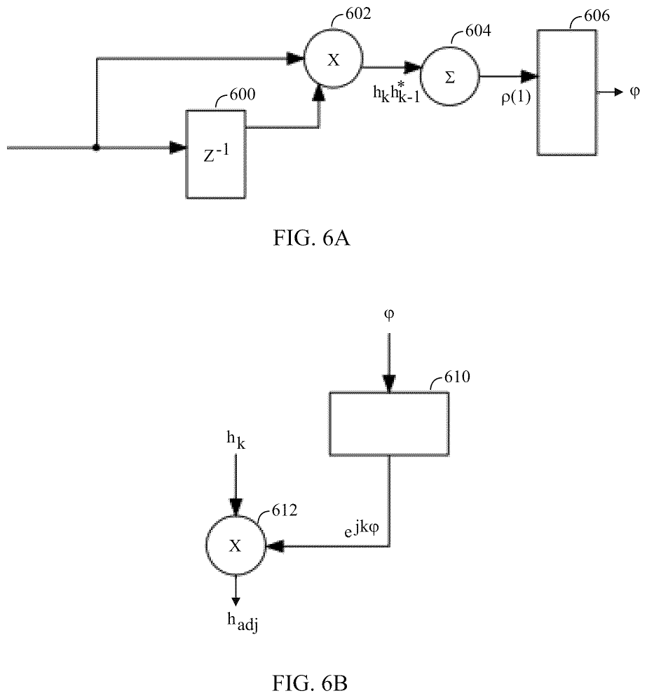

The phase change across subcarriers can be averaged out and is a measure of the excess delay. That is illustrated in FIG. 6A. For this, a d-space algorithm may be chosen, and the autocorrelation p_{(d)} of the frequency domain channel estimate may be computed at lag or delay d=1, for example, without limiting to this value. Block 600 illustrates delay z⁻¹ expressed in the form of the Z-transform. The actual signal and a delayed version of are multiplied in block 602. Then the products are summed over all subcarriers in block 604. Angle of p₍₁₎ directly gives the phase change φ from one subcarrier to next as follows:

$$φ = \frac{angle ( {Σ}_{k = - \frac{{N}_{FFT}}{2}}^{\frac{{N}_{FFT}}{2} - 1} {h}_{k} {h}_{k - d}^{*} )}{d}$$

where

$${h}_{k - d}^{*}$$

is the complex conjugate or h_{k-d}, h referring to the frequency domain channel estimate. The angle j is then formed in block 606. Note that it is not necessary to limit the summation to the number of the fast Fourier transform (nFft) points. For higher bandwidths it may be possible to get a good estimate with a lesser number of samples in the summation and that reduces complexity and saves power. Number of available channel estimates for 20 MHz operation can be given as:

$$\{ \begin{matrix}64 & for Legacy , HT , VHT or 1 x HE - LTF or 1 xEHT - LTF \\ 128 & for 2 xHE - LTF or 2 xEHT - L T F \\ 2 \; 56 & for 4 xHE - LTF or 4 xEHT - L T F\end{matrix}$$

Note that the 20 MHz operation is an example, and the technical solution is not limited to that. The operation may refer to 40 MHz, 80 MHz, 160 MHz or 320 MHZ, for example.

In block 506, the phase change of the channel estimate in the frequency domain is compensated based on the estimate of the phase change expressed in the frequency domain. That means, the excess delay is removed or corrected by multiplying the channel estimate h by e^{jkj}. The purpose of block 506 is to reduce the excess delay in order to increase the frequency domain correlation (smoothness). The excess delay may be re-inserted after smoothing, so that it avoids the requirement of similar excess delay removal computations in the future received OFDM symbols. It is also not possible to remove delay from received MIMO OFDM symbols. (see line from block 506 to block 514). This is a differentiator in this scheme.

Note that the channel estimate corresponds to individual component channels of a MIMO system. There is one frequency domain channel between each of the Tx antenna and each of the Rx antenna. When any LTF is transmitted from different Tx antennas, each transmit signal is cyclically shifted differently. The receiver sees this as a combined signal where there is no single excess delay applicable and possible to estimate as it is the sum of signals from all Tx antennas with different CDDs, which may also be called CSDs (Cyclic Shift Delay). This means that phase cannot be estimated from or compensated on the received signal samples. It can be estimated and compensated from/on the decoupled channel estimates.

In block 510, the channel estimate is smoothed by filtering with a selected set of filter coefficients taken from various sets of filter coefficients. The selected set may depend on a guard interval of the training field or an estimated or given delay spread. A symmetric 9 tap finite impulse response filter (FIR) with programmable real coefficients may be used as channel smoothening filter, for example without limiting to this example. Effectively this requires 5 real multipliers. The filter coefficients are programmable for different guard intervals or estimated/given delay spreads. For each ratio of GI/(N_{FFT}) a separate set of coefficients are required where N_{FFT} is the FFT size before oversampling (1x/2x HE-LTF or 1x/2x EHT-LTF case).

In an embodiment an example of which is illustrated in FIG. 3, the channel data processing arrangement may perform the following prior to the estimation of the phase change: receive a frequency domain channel estimate hᵢₙ of all subcarriers as a vector, and center the vector of coefficients of the channel estimate by setting a DC sub-carrier at the center between the edges of the vector of the coefficients of the channel estimate. The data processing means may receive subcarriers as the vector for each transmitter/receiver antenna pair.

In an embodiment, the compensation of the phase change by the channel data processing arrangement may compensate i.e. remove the phase change resulting from the sum of delays introduced by CDD as well as the average excess delay. The channel data processing means may estimate an average excess delay of each frequency domain channel estimate and correct the average excess delay in the corresponding frequency domain channel estimate. Here, the data processing means may compensate for the cyclic delay diversity of the decoupled channel, possibly, between a transmitter/receiver antenna pair.

In an embodiment, the channel data processing arrangement may interpolate and/or extrapolate the discontinuities caused by null and/or pilot and/or spur affected and/or notch distorted sub-carriers based on one or more neighboring sub-carriers in the frequency domain in block 508 prior to the channel smoothing. The channel data processing arrangement may interpolate discontinuities in frequency domain decoupled channel estimates from their neighbors. Once the excess delay (timing offset) is known as a phase change across samples in frequency domain, it can be corrected. The removal of excess delay in frequency domain results in h_{adj}, and the process can be expressed as follows. The phase generator provides e^{jφk}=cos (φk)+j sin (φk).

$${h}_{a d {j}_{k}} = {h}_{k} \cdot {e}^{jk φ}$$

The formation of h_{adjk} is illustrated in FIG. 6B, the phasor e^{jkj} being formed from j in phasor generator block 610 and the multiplication being performed in block 612. The hardware structures used in carrier frequency offset (CFO) estimation and correction (mixer) may be reused here. The angle calculation may need to be done only once per channel smoothing operation and it may be a shared resource.

In an embodiment, the channel data processing arrangement may perform a linear interpolation and/or extrapolation on the subcarriers prior to channel smoothing in block 508 to mitigate discontinuities in each channel frequency response corresponding to null sub carriers, DC subcarriers, differently modulated pilot subcarriers, edge carriers outside the band of interest and subcarriers affected by spurious signals or notch filtering.

A symmetric 9 tap FIR filter with programmable real coefficients can be used as channel smoothening filter 510, for example. Effectively this requires 5 real multipliers. The ramp up and ramp down samples outside the edges of the band of interest are discarded. The filter coefficients are programmable for different guard intervals. For each ratio of GI/(N_{FFT}) a separate set of coefficients are required where N_{FFT} is the FFT size before oversampling (1x/2x HE-LTF 1x/2x EHT-LTF case). As an example, see Table 27-19 (HESU/HEERSU/HEMU/EHTSU/EHTERSU/EHTMU) and Table 27-20 for the corresponding smoothing filter coefficients. Note that all frame formats are considered in the table, not merely HEMU. EHT PPDUs have the same GI/nFft ratios as HE (for example HEMU-2x-HELTF has the same GI and Tu as EHT-MU-2xEHT-LTF and so forth).

TABLE 27-19

| | | | Ratio |
|---|---|---|---|
| format | GI(μs) | Tu(μs) | (R) |
| HETB 1xHELTF1.6 us | 1.6 | 3.2 | ½ |
| Legacy/HT/VHT | 0.8 | 3.2 | ¼ |
| HESU/HEERSU/EHTSU/EHTERSU 1x | 0.8 | 3.2 | ¼ |
| HE-LTF and 0.8 μs GI | | | |
| HESU/HEERSU/EHTSU/EHTERSU 2x | 1.6 | 6.4 | ¼ |
| HE-LTF and 1.6 μs GI | | | |
| HESU/HEERSU/EHTSU/EHTERSU 4x | 3.2 | 12.8 | ¼ |
| HE-LTF and 3.2 μs GI | | | |
| HEMU/EHTMU 2x HE-LTF and 1.6 μs GI | 1.6 | 6.4 | ¼ |
| HEMU/EHTMU 4x HE-LTF and 3.2 μs GI | 3.2 | 12.8 | ¼ |
| SGI (HT/VHT) | 0.4 | 3.2 | ⅛ |
| HESU/HEERSU/EHTSU/EHTERSU 2x | 0.8 | 6.4 | ⅛ |
| HE-LTF and 0.8 μs GI | | | |
| HEMU/EHTMU 2x HE-LTF and 0.8 μs GI | 0.8 | 6.4 | ⅛ |
| HESU/HEERSU/EHTSU/EHTERSU 4x | 0.8 | 12.8 | 1/16 |
| HE-LTF and 0.8 μs GI | | | |
| HEMU/EHTMU 4x HE-LTF and 0.8 μs GI | 0.8 | 12.8 | 1/16 |

The following table shows filter coefficients for each ratio. The text in bold italics need not be stored as the filters are symmetric.

TABLE 27-20

| tap | R = ½ (HETB) | R = ¼ | R = ⅛ | R = 1/16 |
|---|---|---|---|---|
| 1 | 0.0186 | −0.0128 | 0.0221 | 0.0352 |
| 2 | −0.0205 | 0.0102 | 0.0685 | 0.0818 |
| 3 | −0.0851 | 0.1086 | 0.1287 | 0.1293 |
| 4 | 0.2748 | 0.2416 | 0.1804 | 0.1647 |
| 5 | 0.6243 | 0.3049 | 0.2008 | 0.1779 |
| 6 | 0.2748 | 0.2416 | 0.1804 | 0.1647 |
| 7 | −0.0851 | 0.1086 | 0.1287 | 0.1293 |
| 8 | −0.0205 | 0.0102 | 0.0685 | 0.0818 |
| 9 | 0.0186 | −0.0128 | 0.0221 | 0.0352 |

Channel Interpolation (oversampling) is required if 1x or 2xHE-LTF and 1x or 2xEHT-LTF is used. In these two cases, unlike 4x-EHT-LTF, 4x-HE-LTF, Legacy, HT or VHT, every fourth (in case of 1x-HE-LTF and 1x-EHT-LTF) or second (in case of 2x-HE-LTF and 2x-EHT-LTF) subcarrier is loaded and transmitted. The usable symbol duration may be either one fourth or half of the full length HE/EHT symbol duration, for example, not limiting to this. The channel estimates for the intermediate subcarriers need to be estimated from the known channel estimates adjacent to them. To improve channel correlations and hence reduce error in interpolating missing subcarriers, the excess delay is removed in frequency domain. This operation is already part of channel smoothing.

The preconditions for channel oversampling are:
Channel estimation is done for HE OFDM packets from HE-LTF symbols or EHT OFDM packets from EHT-LTF symbols
Channel estimates are arranged in ascending order of subcarrier indices [-nFft/2, nFft/2-1]
Gamma rotations are removed and pilots/dc/null/spur affected/notch distorted positions are interpolated/extrapolated with nearest loaded subcarriers.
Excess delay is estimated and removed from each channel estimate in frequency domain. Smoothing filter, if enabled, is applied on all spatial channels.

Channel estimates at pilot positions are saved and then replaced with interpolated values. Null carriers and/or DC subcarriers are also interpolated or extrapolated before filtering. The above operations may be performed as a part of the channel smoothing operation. The smoothing filter output is fed into the interpolator/over-sampler.

In an embodiment, the channel data processing arrangement may form the phase change relating to the time shift of synchronization between reception and symbol boundaries of the channel symbols for the compensation of the phase change. The phase change may be measured as an angle that may be defined as a function of an inverse tangent of autocorrelation between the channel symbols over d as explained about the d-space algorithm.

In an embodiment, the channel data processing arrangement may multiply the decoupled channel estimate between, possibly, each transmitter/receiver antenna pair expressed in the frequency domain by a counter-phase-shift expressed in the frequency domain for compensating the phase shift, the counter-phase-shift being defined by the angle relating to the time shift.

In an embodiment, the channel data processing arrangement may perform the channel smoothing without ramp up and ramp down symbols. Here the ramp up and ramp down symbols refer to channel estimates formed by extrapolating the edge null subcarriers from loaded neighbors. The ramp up and ramp down samples can thus be discarded. This may be achieved by extrapolating outside the frequency band of interest if they are not available or using loaded subcarriers outside frequency band of interest if they are available. Extrapolation could be a linear interpolation from nearest loaded subcarriers or repetition of nearest loaded subcarrier or a combination of both.

The effect of ramp up/down may be minimized by having extra subcarriers outside the edge of interest where there are nulls. This could be performed in three ways, for example: 1) extrapolate from loaded subcarriers inside the band edge, 2) repeat the last available subcarrier outside the edge, and/or 3) potentially subcarriers outside the band edge may also be used.

In an embodiment, the channel data processing arrangement may remove complex gamma rotations prior to the phase change estimation.

In an embodiment, the channel data processing arrangement may oversample decoupled channel estimates from 1x and/or 2x high-efficiency long training field (HE-LTF) and/or extremely-high-throughput long training field (EHT-LTF) type in block 512. In an embodiment, the phase compensation is reinserted in conjunction with the filtering in block 514. In an embodiment, the channel coefficients of pilots saved in block 502 may be restored in block 516. In an embodiment, the gamma rotations may be reinserted by multiplying with the complex conjugate of the gamma factors in block 518. Then a smoothened channel estimate is output.

In an embodiment, the channel data processing arrangement may form an average excess delay as a center of gravity of the channel impulse response power for maximizing correlation across the sub-carriers prior to the channel smoothing.

In an embodiment, the channel data processing arrangement may reduce an average delay of the excess delay for maximizing correlation across the sub-carriers prior to the channel smoothing.

Estimate the channel at all missing subcarriers by oversampling (by a factor of 2 or 4) which can be performed by passing appropriately zero inserted samples into a linear Interpolating filter. The candidate algorithm linearly interpolates the rectangular coordinates (real and imaginary parts) from loaded subcarriers onto unloaded subcarriers nearby within a resource unit (RU).

For 2×HELTF and 2xEHTLTF channel estimates, for example, at every second subcarrier are available and hence zero insertion by a factor of 2 and a linearly interpolating filter of [1 2 1]/2 can be used for finding missing channel estimates. For 1×HELTF and 1×HELTF channel estimates at every fourth subcarrier are available and hence zero insertion by a factor of 4 and a linearly interpolating filter of [1 2 3 4 3 2 1]/4 can be used for finding missing channel estimates. Values ½, 2/4, ¾, ¼ are weights.

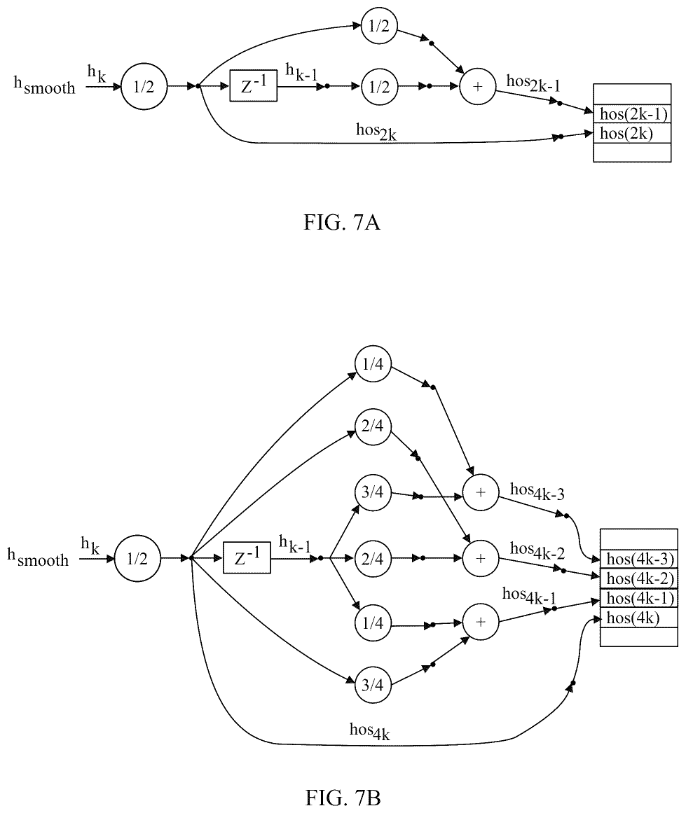

The implementation of making use of the zero insertions will reduce hardware multipliers (polyphase structure).
Interpolation needs to be performed for required subcarriers in the required resource unit (RU) only.
For the band edges, where interpolation is not possible, it is possible to extrapolate from the nearest available loaded subcarriers. That may mean the nearest two subcarriers. The other option is repeat the nearest loaded subcarrier.
   An example scheme for 1x and 2x HE/EHT-LTF are illustrated in FIGS. 7A and 7B. The delay is represented by z⁻¹ of the Z-transform. The rational numbers appearing in FIGS. 7A and 7B are coefficients or weights by which the signal can be multiplied.

Note that the prior art performs estimating and compensating delay or phase from/on signal from (two) receivers RX1 or RX2, whereas this document teaches operation on decoupling channel responses Hxx for each subcarrier. The channel responses Hxx can be derived from the signals of the receives RX1 and RX2 by the decoupling process based on what is transmitted from transmitters TX1 and TX1. Although it is not possible to estimate or correct delay from/on the receivers RX1 or RX2, it is possible do it on any of the channel responses Hxx.

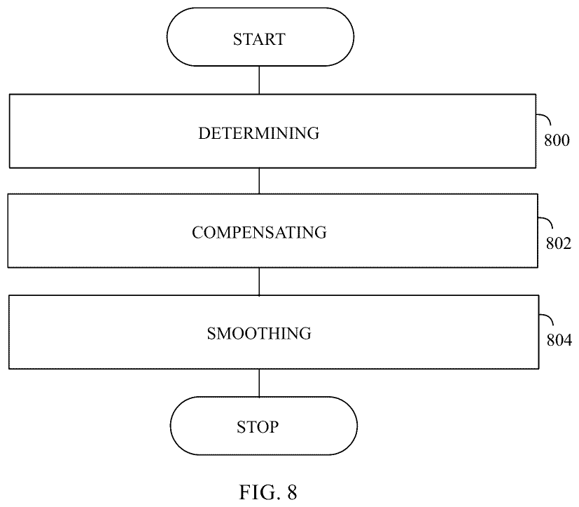

FIG. 8 is a flow chart of the method for performing channel smoothing related to a wireless radio system of an orthogonal frequency division modulation (OFDM). In step 800 an estimate of a phase change caused by excess delays of received OFDM symbols is estimated based on channel symbol comparisons in frequency domain. In step 802, the phase change of the channel estimate is compensated in the frequency domain based on the estimate of the phase change expressed in the frequency domain. In step 804, the channel estimate is smoothened by filtering with a selected set of filter coefficients of various sets of filter coefficients, the selected set depending on a guard interval of the training field and/or delay spread that is estimated and/or given or combination of both.

Note that a few steps in processing decoupled channels relate to a differentiator. In short, the block/step may be as follows: 1) decouple channels, 2) save pilots, 3) remove gamma rotations, 4) determine excess delay (phase) from decoupled channel estimate without pilot, null, spur, notch subcarriers, 5) compensate for average excess delay estimated, 6) interpolate pilots/nulls/spurs/notch to remove discontinuities, 7) apply smoothing filter, 8) oversample in case of 1x and 2x channels, 9) reinsert the excess delay, 10) reinsert gamma rotations and 11) Reinsert pilots.

In the technical solution, the phase compensation is reinserted in conjunction with the filtering. That has the technical advantage that the same compensation does not need to be applied on all the received OFDM symbols of the channel afterwards.

The method shown in FIG. 8 may be implemented as a logic circuit solution or computer program.

It will be obvious to a person skilled in the art that, as technology advances, the inventive concept can be implemented in various ways. The invention and its embodiments are not limited to the example embodiments described above but may vary within the scope of the claims.

1. A receiving apparatus for performing channel smoothing related to a wireless radio system of an orthogonal frequency division modulation (OFDM), wherein a receiver apparatus means comprises a channel data processing means that is configured to
determine an estimate of a phase change caused by excess delays of received OFDM symbols based on channel subcarrier symbol comparisons in frequency domain;
compensate the phase change of the channel estimate in the frequency domain based on the estimate of the phase change expressed in the frequency domain; and
smooth the channel estimate by filtering with a selected set of filter coefficients of various sets of filter coefficients, the selected set depending on a guard interval of the training field and/or delay spread that is estimated and/or given.

2. The apparatus of claim 1, wherein the channel data processing means is configured to perform the following prior to the estimation of the phase change
receive a frequency domain channel estimate of all subcarriers as a vector;
center the vector of coefficients of the channel estimate by setting a DC sub-carrier at the center between the edges of the vector of the coefficients of the channel estimate.

3. The apparatus of claim 1, wherein the compensation of the phase change by the channel data processing means is configured to compensate cyclic delay diversity (CDD) in conjunction with the compensation of the phase change related to the excess delay.

4. The apparatus of claim 1, wherein the channel data processing means is configured to interpolate and/or extrapolate null and/or pilot sub-carriers based on one or more neighboring available or loaded sub-carriers in the frequency domain prior to the channel smoothing.

5. The apparatus of claim 2, wherein the channel data processing means is configured to perform a linear interpolation and/or extrapolation on the subcarriers prior to channel smoothing.

6. The apparatus of claim 5, wherein the channel data processing means is configured to save channel coefficients of pilot sub-carriers prior to the interpolation for processing posterior to channel smoothing.

7. The apparatus of claim 1, wherein the channel data processing means is configured to form the phase change relating to the time shift of synchronization between reception and symbol boundaries of the channel symbols for the compensation of the phase change.

8. The apparatus of claim 7, wherein the channel data processing means is configured to multiply the channel estimate expressed in the frequency domain by a counter-phase-shift expressed in the frequency domain, the counter-phase-shift being defined by the angle relating to the time shift.

9. The apparatus of claim 1, wherein the channel data processing means is configured to perform the channel smoothing without ramp up and ramp down subcarrier symbols.

10. The apparatus of claim 1, wherein the channel data processing means is configured to remove gamma rotations prior to the phase change estimation.

11. The apparatus of claim 1, wherein the channel data processing means is configured to oversample 1x and/or 2x high-efficiency and/or extremely-high-throughput long training field type.

12. The apparatus of claim 1, wherein the channel data processing means is configured to form an average excess delay of the delay spread as a center of gravity of the channel impulse response power for maximizing correlation across the sub-carriers prior to the channel smoothing.

13. The apparatus of claim 1, wherein the channel data processing means is configured to reduce an average delay of the excess delay for maximizing correlation across the sub-carriers prior to the channel smoothing.

14. The apparatus of claim 1, wherein the channel data processing means is configured to estimate an average excess delay of the received OFDM signal from the frequency domain channel estimates, and correct the average excess delay in the frequency domain.

15. A method for performing channel smoothing by a receiver of a wireless radio system of an orthogonal frequency division modulation (OFDM), the method comprising
determining an estimate of a phase change caused by excess delays of received OFDM symbols based on channel symbol comparisons in frequency domain;
compensating the phase change of the channel estimate in the frequency domain based on the estimate of the phase change expressed in the frequency domain; and
smoothing the channel estimate by filtering with a selected set of filter coefficients of various sets of filter coefficients, the selected set depending on a guard interval of the training field and/or delay spread that is estimated and/or given.
